(19) United States
(12) Patent Application Publication
(10) Pub. No.: US 2009/0319957 A1
(43) Pub. Date: Dec. 24, 2009

(54) SELECTION SYSTEM

(75) Inventor: Mark Adrian Blakey, Victoria (AU)

Correspondence Address: KNOBBE MARTENS OLSON & BEAR LLP, 2040 MAIN STREET, FOURTEENTH FLOOR, IRVINE, CA, 92614, US

(73) Assignee: MAINSTREAM COMPUTING PTY LTD, Victoria (AU)

(21) Appl. No.: 12/162,767

(22) PCT Filed: Jan. 25, 2007
(86) PCT No.: PCT/AU2007/000075

§ 371 Date: Dec. 23, 2008

Related U.S. Application Data
(60) Provisional application No. 60/762,905, filed on Jan. 30, 2006.

(30) Foreign Application Priority Data
Jan. 30, 2006 (AU) 2006900435

(51) Int. Cl. G06F 3/048

(52) U.S. Cl. 715/854; 715/825; 715/810

(57) ABSTRACT

A selection system, including: (a) a user interface for use in selecting an item, the user interface being served to and stored on a user device only for the duration of a session, and for providing categories, selection criteria and item data selectable using the device; and (b) a server component for serving the user interface for the session, for serving only category data during the session, in response to selection of one of the categories when the category is not a leaf category, to change the categories provided by the user interface, and for serving only selection criteria and item data during the session in response to selection of a leaf category of the categories.

### FIELD

The present invention relates to a selection system, process and engine.

### BACKGROUND

Public communications networks, such as the Internet have become a primary source of information for consumers seeking to research, browse, select and buy products, such as goods or services, and to obtain information on a wide variety of items. An item, as referred to herein, is any object or resource that can be categorised, in that it can be organised into categories and/or it possesses discrete identifiable characterising properties. For example, an item may be a good, a service, a job advertisement, a news article, etc.

A number of systems are available on the Internet that organise items into categories and allow item consumers to select items by browsing and selecting the categories or provide keyword-based search engines to generate results and/or supply advertisements. A common problem with current category oriented systems is that their user interfaces do not provide an efficient method of exploring, navigating or effectively using the hierarchical relationships that may exist between categories of items. One of the principle problems is that to proceed from one category to another, an entire web page has to be downloaded, creating a source of significant delay (even with higher speed broadband Internet connections) that discourages exploring the hierarchy of categories and hence discourages consumers from considering wider selections of items. As such, existing online shopping facilities face a significant barrier that does not exist in physical shops. A person traversing the isles of a physical supermarket does not have to wait before proceeding between isles (ie the analogue of proceeding between categories using an Internet selection based system) or between shops in a shopping mall. Consequently, online shops tend to present many more items in each category, and many more categories at a time, forcing consumers to constantly face an uncomfortable number of choices and volume of information at one time.

Some systems download all category and/or item information at session commencement to enable a faster and localised usage by the end user. This approach is fundamentally flawed for larger data sets as the initial download and startup time rapidly becomes unacceptable with the result that consumers abandon sessions before even commencing a browse process.

A further problem is that within a particular category, there are often many more items of a desired kind on offer than a typical consumer may wish to consider at one time. As an example, there are today over 300 models of digital still cameras on the market. Even if a method of efficiently navigating to that category was offered, pre-existing services only offer very limited mechanisms to usefully restrict the choices in a pleasing or useful way.

It therefore remains difficult for consumers using the current systems to rapidly identify a short-list of items of best fit or greatest interest. Users of existing selection systems are also often presented directly with web pages detailing specific items that appear to be presented for no discernible reason.

Selection systems tend to be of two kinds: (a) public selection systems in which public services (eg shopping related facilities operated by companies such as Google Inc. and Yahoo Inc.) are operated by third parties (ie parties other than item suppliers) and contain the items of multiple manufacturers and the advertisements of multiple retailers; and (b) private selection systems operated by a party with a vested interest in the items represented as an adjunct to that party's website, generally without any third-party advertising content.

Both public and private selection systems tend to store information on central database servers and provide simple HTML web page user interfaces to accept user queries and deliver results (including advertising content if applicable).

Where multiple kinds or large numbers of items are to be represented, a selection system should enable an operator to respond rapidly to changing products, market conditions, promotional requirements by (a) altering the hierarchy of categories offered, (b) controlling the listing ordering of categories, (c) offering certain new or featured products first (when all other criteria would not discriminate between an ordering), (d) controlling which selection criteria may be offered in each category, (e) controlling the order of presentation of selection criteria in each category, (f) connecting values to selection criteria, (g) setting the range of valid values or choices associated with selection criteria, and (h) controlling whether and which items or item categories are to be offered as suggested areas of additional interest (eg to provide more information and to support cross-selling products) under each category.

Operators of private selection systems are generally concerned about the branding and “look and feel” of all aspects of their websites. Operators should be able to control and customise the user interface of their selection system so that it appears to be a natural inbuilt part of a website rather than an external or third-party appliance.

Many operators of selection systems wish to be able to obtain and analyse customer behaviours, both on an individual session basis and in the form of multi-session aggregate statistics in order to assess (a) the effectiveness of particular designs of category hierarchies and selection criterias, (b) the popularity of individual items, (c) the effectiveness of sales and marketing campaigns and other initiatives, and (d) the contribution of the selection system itself. Also operators of selection systems wish to be able to administer database contents in advance, and to apply future dates so that new products are not disclosed prior to planned launch dates, and can be expired (ie cease to be offered) on planned dates if applicable.

Accordingly, it is desired to address or alleviate the above or to at least provide a useful alternative.

### SUMMARY

In accordance with the present invention there is provided a selection system, including:
a user interface for use in selecting an item, said user interface being served to and stored on a user device only for the duration of a session, and for providing categories, selection criteria and item data selectable using said device; and
a server component for serving said user interface for said session, for serving only category data during said session, in response to selection of one of said categories when the category is not a leaf category, to change said categories provided by said user interface, and for serving only selection criteria and item data during said session in response to selection of a leaf category of said categories

The present invention also provides a selection engine, stored on computer readable media, including:

a user interface part served and stored on a computer device during a user session; and

a server part for responding to requests from the user interface part to serve only item, category or selection criteria data during said session for said interface.

The present invention also provides a selection engine, stored on computer readable media, including:
a user interface for use in selecting an item, said user interface being served to and stored on a user device only for the duration of a session, and for providing categories, selection criteria, and item data selectable using said device; and
said user interface receiving during said session only category data, in response to selection of one of said categories when the category is not a leaf category, to change said categories provided, and for receiving only selection criteria and item data during said session in response to selection of a leaf category of said categories.

The present invention also provides a selection system including:
means for serving a user interface for storage on a device only for the duration of a user session for use in selecting an item, said user interface providing selectable categories, selection criteria and item data;

means for serving only category data during said session, in response to selection of one of said categories when the category is not a leaf category, to change said categories provided by said user interface; and
means for serving only selection criteria and item data during said session in response to selection of a leaf category of said categories.

The present invention also provides a process, performed by a selection system, including:
serving a user interface, for storage on a device only for the duration of a user session, for use in selecting an item, said user interface being adapted to provide selectable categories, selection criteria and item data;
serving only category data during said session, in response to selection of one of said categories when the category is not a leaf category, to change said categories provided by said user interface; and
serving only selection criteria and item data during said session in response to selection of a leaf category of said categories.

The present invention also provides a selection system, including:
storage means storing first index data associating categories with items and selection criteria, and storing second index data associating items with attributes; and
response means processing request messages, in response to a selected category and selection criteria of the category, to serve item data for items of the selected category having attributes with data values corresponding to at least one data value of the selected selection criteria.

### BRIEF DESCRIPTION OF THE DRAWINGS

Preferred embodiments of the present invention are hereinafter described, by way of example only, with reference to the accompanying drawings, wherein:

FIG. 1 is a block diagram of a selection system environment;

FIG. 2 is a block diagram of a preferred embodiment of a selection system in accordance with the present invention;

FIG. 3 is a block diagram of the components of a selection engine of the system of FIG. 2;

FIG. 4 is a flow diagram of process performed by an interface component of the selection engine;

FIG. 5 is a flow diagram of process performed by a request processor component of the selection engine;

FIG. 6 is a flow diagram of a navigation and selection process performed by the selection engine;

FIGS. 7A to 8C are diagrams of example interfaces generated by the selection engine;

FIG. 9 is a logic flow diagram of processes performed by the selection engine; and

FIG. 10 is a flow diagram of an item determination process of FIG. 9.

### DETAILED DESCRIPTION OF THE PREFERRED EMBODIMENTS

A selection system 120, as shown in FIG. 1, provides facilities to enter or upload, maintain and deliver item data. Item data includes any data representing or related to an item, and includes data representing summary, descriptive, promotional, advertising, specification information and other information about an item. Item data may include any form of multi-media content, such as text, graphics, images, video, sound and music files. Item data may also embed data such as a link and/or machine executable instructions. A number of item supplier systems 110 may directly, or indirectly, enter, maintain, and track item data in the selection engine system 120. Item consumer systems 130 may submit requests for item data to, accept item data in response to their requests from, and provide usage data to, the selection engine system 120. The usage data may represent measured or observed item consumer behaviour related to item data that has been served.

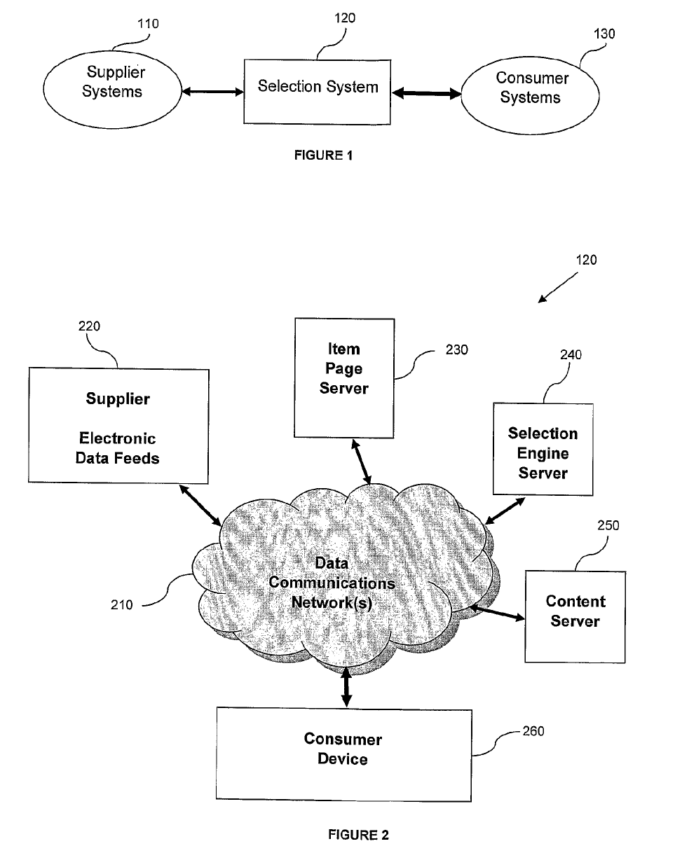

The selection system 120, as shown in FIG. 2, includes a selection engine server 240, servers 220, 230 and 250 which may be operated by various parties (and generally differing from the operator of server 240), and can also be considered to include at least one consumer device 260 as components of the system are served to and stored on a consumer device 260 during a session. The consumer device 260 is a client machine that can be used by a consumer, and may be a computer device, such as a personal computer (such as those produced by Lenovo Group Limited and Apple Computer, Inc.), mobile or cellular telephone, or PDA, that includes a browser (such as either a Internet Explorer, Firefox or Safari) able to communicate with a public communications network 210, such as the Internet, using Internet communications protocols, such as HTTP(s), or other similar communications protocols, such as WAP. The consumer device 260 includes a display for displaying user interfaces rendered by the browser.

The selection engine server 240 can connect to consumer devices 260 using various communications protocols via the network 210. Item supplier systems 220 can also connect via the network 210 to the selection engine server 240 to provide item data using protocols based on content syndication, such as the Really Simple Syndication (RSS) protocol. Suppliers or others may also operate websites or other facilities 230 that provide more detailed item data pages and/or purchasing systems, order tracking and other commerce and consumer related functions to consumer devices 260, using various communications protocols with links to the facilities 230 being invoked by consumer devices 260 interacting with the selection engine server 240. Item data of the selection engine server 240 may also include links or references to any other third party systems 250 offering additional content, such as advertisements, also accessible over the communications network 210.

Supplier data feed servers 220, item page servers 230, the selection engine server 240 and content servers 250 may all reside on distributed computer servers (such as those provided by IBM Corporation) running standard operating systems (such as Linux or Microsoft Windows), or, if desired, can be combined and implemented on one or more computer servers. The computer servers each include computer readable storage media (e.g. hard disk, optical disk, magnetic tape, RAM, ROM, etc.) for storing the software components of the servers 220, 230, 250 and the selection engine server 240. The software components, as described below, comprise computer program code instructions and data. Those skilled in the art will appreciate that the processes performed by any of the software components, can also be executed at least in part by dedicated hardware circuits, e.g. application specific integrated circuits (ASICs) or field-programmable gate arrays (FPGAs).

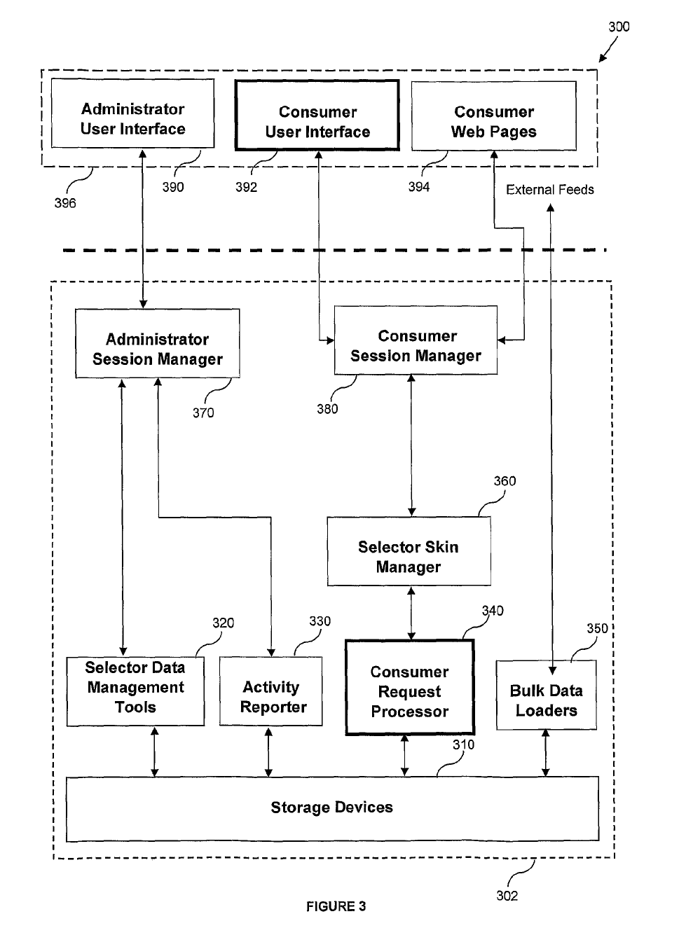

A selection engine 300, as shown in FIG. 3, is stored on the server 240 and includes components 302 that would normally be resident and remain on the server 240, and components 396 that are served by the server 240 and are resident on the consumer device 260 when the selection system 120 is used by a consumer. The components 302 and 396 are discussed below.

Storage devices 310 are used to store and provide access to data used by the engine 300. The devices 310 include any form of computer readable media (e.g. hard disk, optical disk, magnetic tape, RAM, ROM, or any combination of these).

A consumer request processor 340 includes processes and logic for translating requests and activity from consumer devices 260 onto operations on the storage devices 310, and for assembling and processing responses for delivery to consumer devices 260.

A selector skin manager 360 combines responses from the consumer request processor 340 with specifically styled and possibly customised user interface details prepared to match the visual characteristics (such as the branding conventions for use of colours, fonts, logos and seasonal messages) of the item page servers 230 and/or the content servers 250, and serve to vary the general characteristics of user interface layouts of the engine 300, according to particular requirements of a party operating the selection engine 300.

A consumer session manager 380 enables multiple consumer devices to engage in simultaneous sessions which involve several interactions between the server side components 302 and the remote components 396 of the selection engine 300. The session manager 380 services the user interface 392.

A much higher degree of interactivity and a much lower volume of data exchange (between parts 396 and 302) is achieved, as described below, by rendering and executing the consumer user interface 392 locally on the consumer device 260 such that the user interface 392 need only be downloaded and rendered once at the commencement of a user session, and the request processor 340 only serves specific data to be inserted, substituted and deleted dynamically during the session. The interface 392 and the processor 340 only transfer data relating to presently required categories, selection criteria and items between the components 396 and 302 of the engine 300. Most of the interface 392 is implemented using standard code, such as HTML, Javascript and Macromedia Flash, with the dynamic processing component of the interface 392 implemented using AJAX (Asynchronous JavaScript and XML) or Macromedia Flash.

A category is a member of a hierarchical classification system of the selection engine 300 that organises item data into classes possessing common property attributes. Categories can be subordinate to one another and any number of categories can exist at each level and any number of levels of categories are permitted. Categories may contain either sub categories or item data but not both. Categories containing item data are referred to as leaf-categories. An item attribute is a quality of an item, such as its weight, size, colour, price, etc. The foregoing are all examples of item attributes possessing data values: a weight might be 3 KG, a size be 1.3 M, a colour might be blue, a price might be $257. Other item attributes are inherently boolean in that they either apply to that item or do not. Some examples of boolean property attributes are “ATM access provided” in relation to an item representing a credit card product (ie if TRUE, the credit card can be used at an automatic teller machine), and “digital zoom” in relation to a digital camera (ie if TRUE the camera offers digital zoom). Other item attributes may have values limited only to a set of discrete data values and are referred to discrete-value item attributes. One example of this latter type might be “access modes” in relation to an item representing a bank account product which might have values such as “ATM”, “Internet Bank” and “Branch”. Finally, choice item attributes enable the selection of one value at a time between several predefined alternatives. For example the “colour” of an item representing a product might be one of “red”, “blue” or “green” but cannot be more than one at a time. The data values of the item attributes can be considered to form part of the item data for an item.

Selection criteria are a set of desired item attribute types and data values.

An item may have zero or more item attributes associated with it. Each item attribute can be associated with zero or more items and can possess zero or more data values. Many associations of either kind may be made and many items or item attributes may exist.

The data held about a category represents (a) its name, (b) (i) the categories that are subordinate to that category (if not a leaf-category) or (ii) the items and any selection criteria linked to that category (if a leaf-category), and (c) cross references to related categories.

The selection criteria of a category can either (a) default to be the superset of attribute types and data values of all items linked to that category, or (b) be limited to any set of attributes, each with limited data values ranges or choices.

Any number of categories and any number of subordinate relationships between categories is permissible.

An item can be linked to any number of categories. The selection engine 300 only renders selection criteria and items (i.e content for items) when leaf-categories are selected using the user interface 392.

For cases in which (a) a consumer device 260 can not use the interactive consumer user interface 392 (perhaps where the user has disallowed certain features of their browser software or is using older or less capable browser software), and (b) where selection engine web crawlers could not traverse interactive interfaces, the selection engine 300 can also serve item content in the form of standard HTML pages 394. In that case, the system can generate menus to enable category selection to ensure that full discovery of all item data available is possible.

Selector data management tools 320 permit a selection engine administrator to setup and maintain categories, item attributes, selection criteria and item data.

An activity reporter 330 enables an administrator to specify, schedule and view reports on data consumer behaviour, item data usage, category usage, and selection criteria applied.

An administrator session manager 370 enables multiple administrators to engage in simultaneous sessions which involve several interactions with the server side components 302 of the selection engine 300. For example, representatives of several companies could each be charged with maintaining item data about differing or overlapping item sets, while an operator of the selection engine 300 would manage categories and selection criteria. An administrator user interface 390 served by the session manager 370 and the management tools 320 enables administrators to administrator content data of the selection engine 300.

Bulk data loaders 350 are able to accept item data and item attributes from suppliers for loading into the storage devices 310.

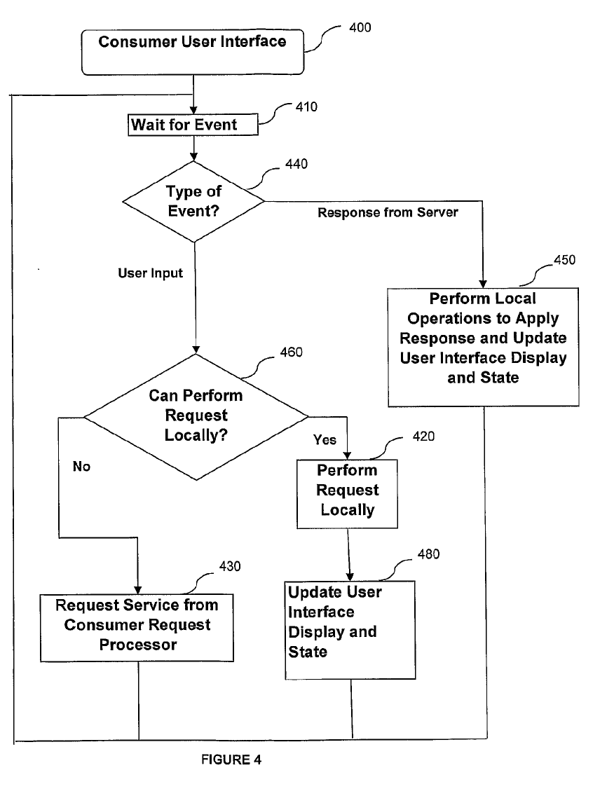

The consumer user interface 392 commences operation at step 400, when received and rendered by the browser of the device 260, as shown in FIG. 4, which represents the general operation of the device components 392. The interface 392 awaits for an event to occur at step 410. Events may occur in response to user input or as a result of the arrival of a response from the remote components 302 of the selection engine 300. An analysis is performed at decision step 440 to determine the type of event that has occurred. If it is ascertained that the event was in response to an action on the user interface then an analysis is performed at decision step 460 to determine whether all necessary processing and data required to complete the operation can be performed locally. If it is ascertained that all necessary data already resides within the memory of device 260 used by the user interface then the operation is immediately performed (step 420), the user interface display and state is updated (480), and the system then returns to await further events. If it is ascertained that additional data is required then a request is composed and dispatched to the request processor 340 (step 430). This involves encoding and packaging the information request in a predetermined transmission in format, such as XML (extended Markup Language).

If the analysis at step 440 ascertains that the event occurred due to a response arriving from the server part 302 of the selection engine 300 then the system proceeds to step 450 where the data obtained is applied to update the state and display of the user interface 392. This data is obtained by decoding or unpacking of the message received and parsing the message.

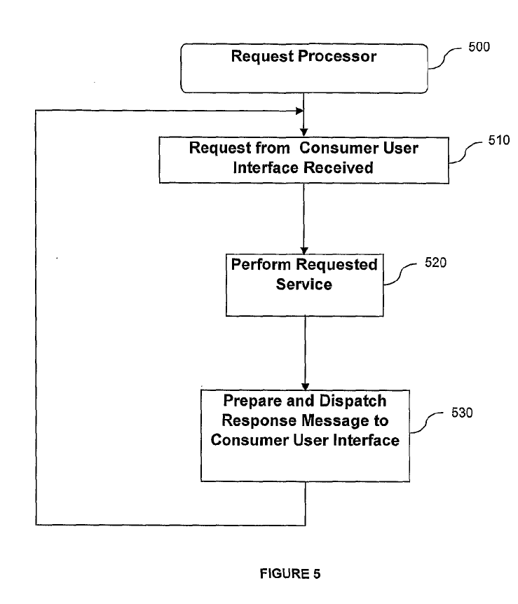

The consumer request processor 340 is invoked at step 500, as shown in FIG. 5, and waits for a data request from a remote user interface 392 when a request is received at step 510. The message is decoded or unpacked, and parsed. A service is then performed locally on the server 240 to obtain the data requested at step 520. The response is then prepared and dispatched back to the remote system 260 at step 530, e.g. by encoding and packaging an XML response for transmission. The processor 340 then proceeds to block 510 to await a further request from the served interface 392.

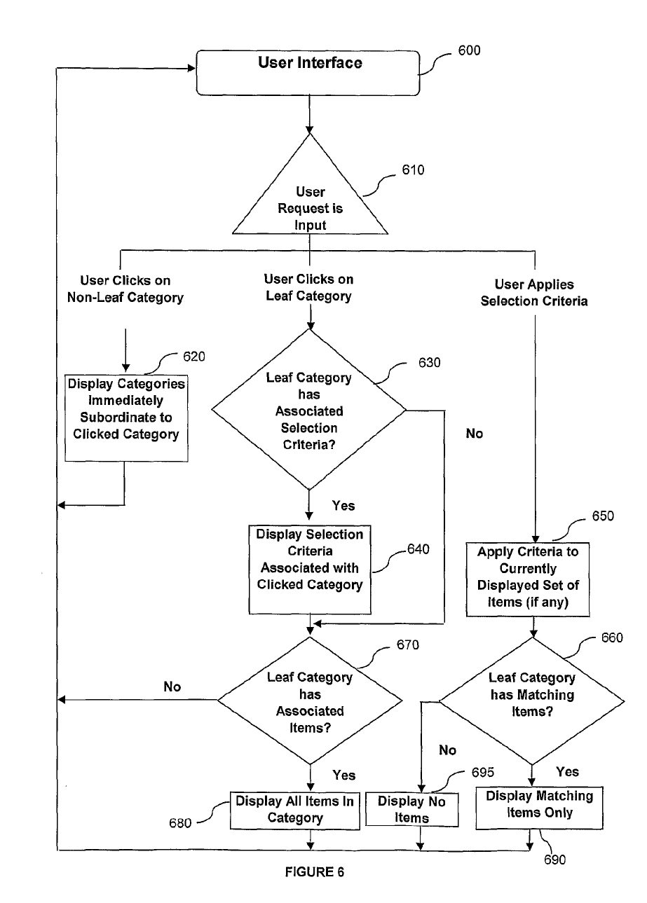

Whilst the above describes the separate processes performed by the components of the selection engine 300, the overall process performed and implemented by the components 392 and 340 is now described with reference to FIG. 6 without detailing precisely how those operations are partitioned between the discrete functional components at different locations.

Once the user interface 392 is served and invoked at step 600 a request can be sent using the user interface 392 by the consumer and is analysed at decision step 610.

If it is determined that the user has clicked on a non-leaf category then the selection engine system 120 proceeds to step 620 to display the set of subordinate categories to the selected category (if any). Items and selection attributes are not rendered in the user interface in this state.

If it is determined that the user has clicked on a leaf-category then the system 120 enters the decision step 630 to determine whether the selected category has any selection criteria associated with it. If it is determined that there are selection criteria associated with the selected leaf-category then the system 120 proceeds to display those criteria in step 640. The system 120 then proceeds (whether or not there were selection criteria to display) to decision step 670 where the currently selected category is queried to determine whether there are any items associated with it. If there are items associated with the current leaf-category then the system proceeds to step 680 to access data for and display all such items (although the material and the number that can be displayed on a page or at one time may be limited). The system then proceeds (in either case) to await further user input at step 600.

If it is determined that the user has applied selection criteria then the system 120 proceeds to step 650 to apply those criteria to the currently displayed set of items. The system then proceeds to decision step 660 to determine whether any items associated with the current leaf-category match the selection criteria currently applied. If they do, the system 120 proceeds to step 690 to display only those items. If no matching items exist then the system 120 proceeds to step 695 to remove all items from display and to inform the user that no items match the current selection criteria applied. In either case, the system 120 then proceeds from steps 690 or 695 to await further user input.

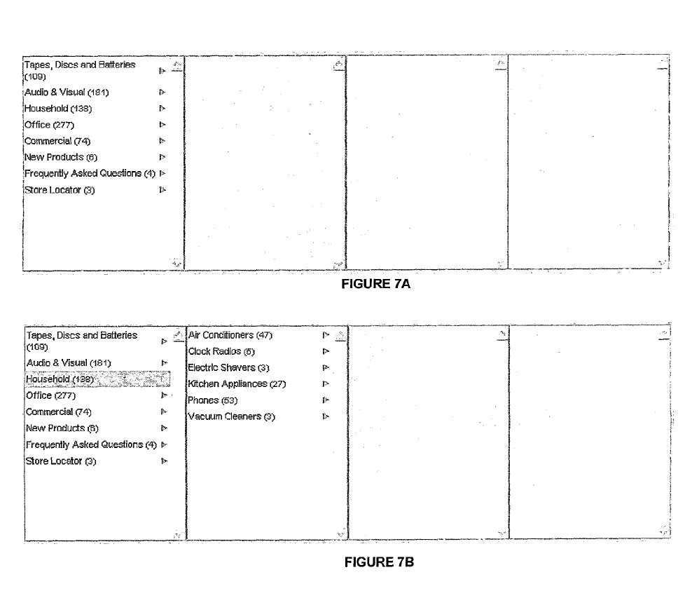

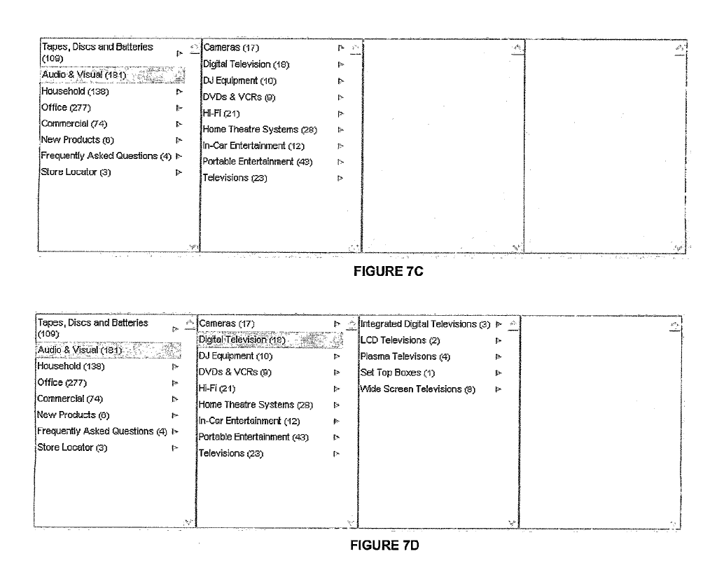

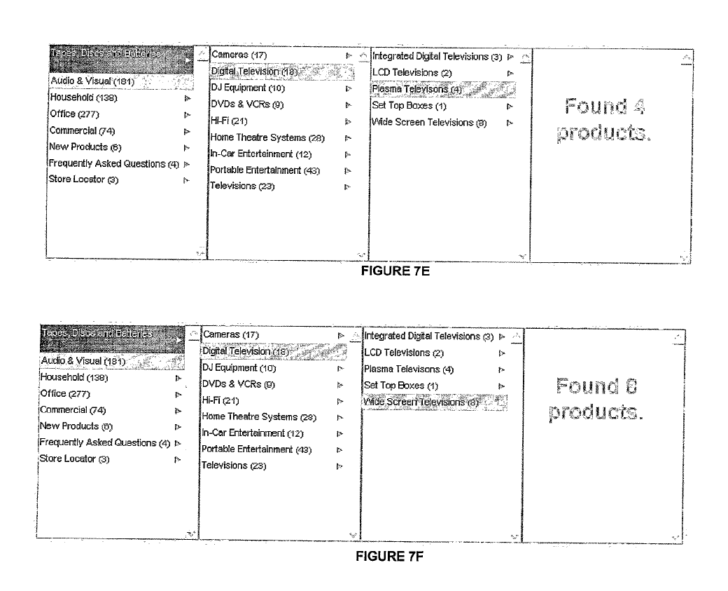

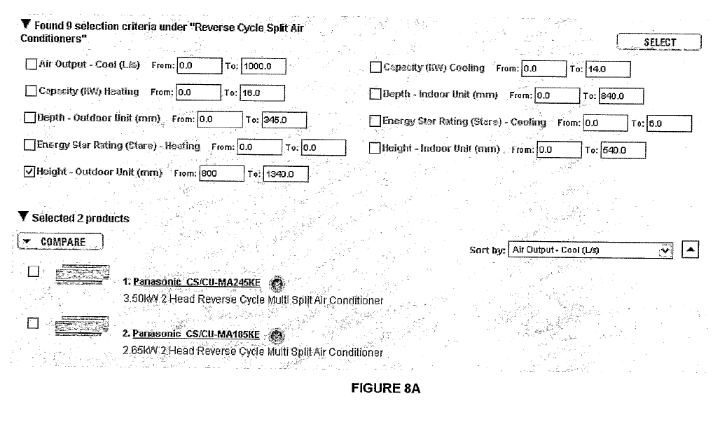

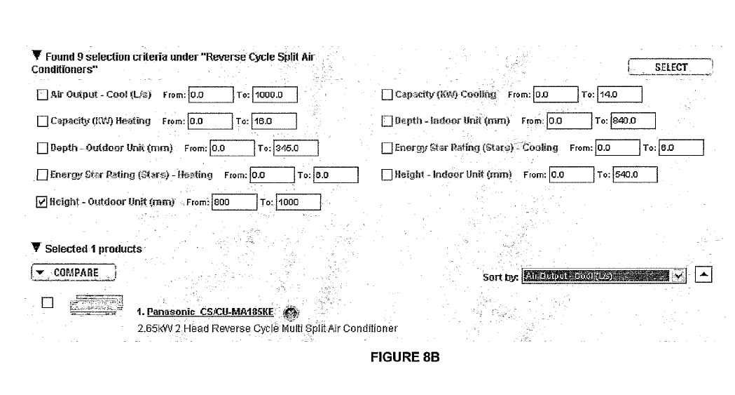

FIGS. 7A to 7F are diagrams illustrating examples of operation of the system 120 in relation to the presentation and organisation of categories, as produced by the user interface 392 and request processor 340. In the particular embodiment depicted, a series of panels are shown for the presentation of categories with the most superior or highest level at the left, the next most superior or next level located to the immediate right, and with less superior or lower level categories proceeding towards the right. Four panels are provided as is a scrolling mechanism to permit any number of levels in the category hierarchy. Many variations could be made, e.g. a smaller or larger number of panels, different scrolling mechanisms and the use of other methods of displaying the hierarchical nature of the category structure (eg a tree structure featuring indented choices arranged vertically) and the set of categories offered at any level (eg a drop-down list showing only the currently selected category at each level).

A count is shown in brackets at the end of each category's name indicating the total number of items associated with the leaf-categories subordinate to the current category. For example in FIG. 7B, the total of numbers shown on the second panel is equal to the number shown on the category “Household”.

FIG. 7A shows the initial view of a typical category hierarchy as at the commencement of a session before the user has made any selections. FIG. 7B shows how the second level of categories is displayed when “Household” is selected by clicking on it in the left-most panel. FIG. 7C illustrates how the contents of the second level category panel are replaced when a different category is selected at the most superior (left-most) level. FIG. 7D illustrates continuing the selection process to a third level of the hierarchy to explore kinds of “Digital Televisions” under “Audio & Visual”. FIG. 7E illustrates the selection of a leaf-category at the third level of the hierarchy (“Plasma Televisions”) and how the system 120 informs the user how many items (products in this case) are associated with that category. FIG. 7F illustrates the selection of an alternative leaf-category and demonstrates how a different number of items have been found (8 rather than 4 in the case shown).

The selection engine 300 loads into the memory of the consumer device 260 none, some or all of the categories at the subordinate levels in advance of their being selected. When a category is selected, the user interface 392 asks the request processor 340 for the data associated with the selected category and the categories of the next n lower levels of the current selected category. The value n is an integer that can be set by the operator of the selection engine 300. As such the user can browse the hierarchy of categories with minimal delay and with optimised network traffic and server load. Accordingly, in the case of more complex category hierarchies involving potentially millions of categories (but not subject to any limit), the selection engine 300 optionally pre-fetches all subordinate categories at a number of levels in advance of the current selection. This enables the selection engine administrator to balance the load on the network resident components 302 of the selection engine 300 and the network traffic between those components and consumer devices 260 with the performance and delay experienced by consumers by selecting an appropriate category pre-fetch policy.

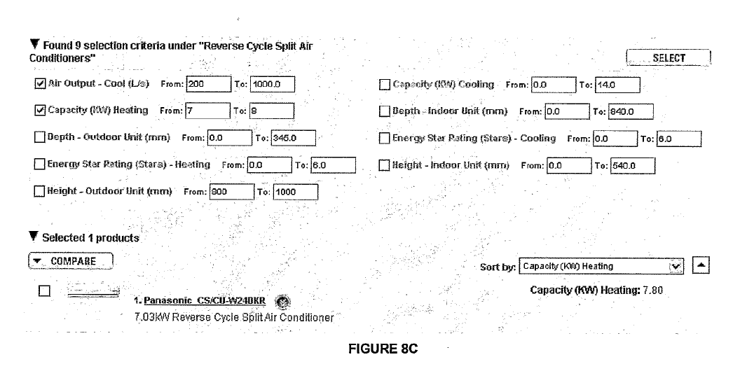

FIGS. 8A to 8C are diagrams illustrating examples of operation of the system 120 in relation to the presentation, specification and application of selection criteria, as produced by the user interface 392 and the request processor 340. In the particular embodiment depicted, the set of selection criteria offered to a consumer is specific to each leaf-category. In the examples shown, the left category selected was “Reverse Cycle Split Air Conditioners”. In other leaf-categories, the set of selection criteria could be completely different. The system 120 offers system administrators an ability to specify which criteria are to be offered in each leaf-category, how many criteria are to be offered, what order they are presented in, and the values that may be applied to each criteria.

FIG. 8A illustrates how the application of a single selection criterion has reduced the set of items (in this case air conditioners) from 9 items to 2 items. The user interface 392 determines the listing order of the selected items as a choice between the selection criteria and other criteria. FIG. 8B illustrates how altering the range of values applied to that same single selection criterion has further reduced the selection to one item. FIG. 8C illustrates how the application of other criteria and the application of multiple selection criteria together has resulted in the selection of different items to those shown in FIGS. 8A and 8B.

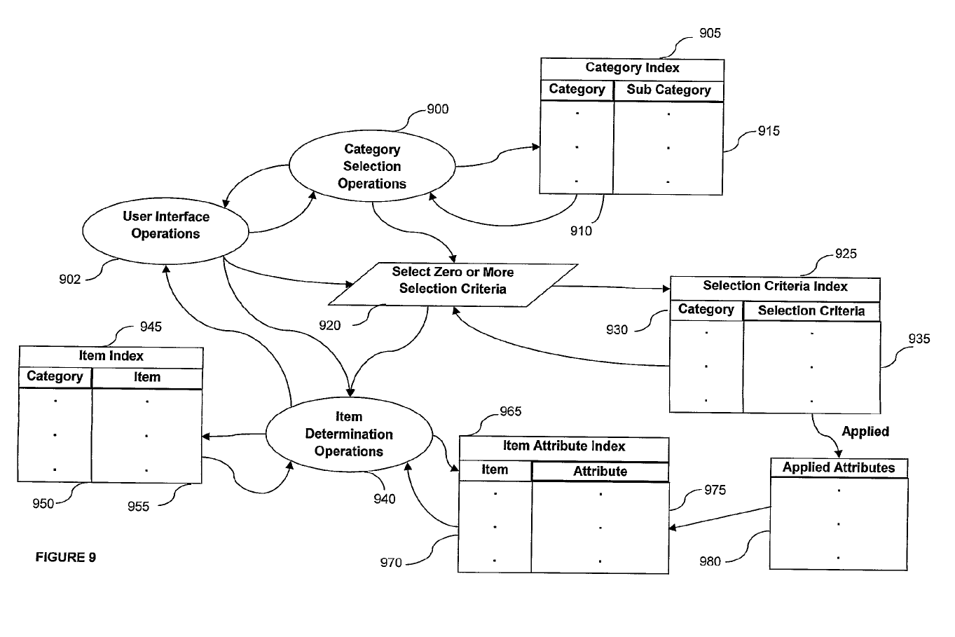

FIG. 9 is a logic flow diagram of processes performed when selecting categories, selection criteria and items using the interface 392. Data tables 905, 925, 945, 965 and 980, discussed below, are held and used only on the remote part 302 of the selection engine 300, and are used in determining the set of categories subordinate to a selected category, the set of selection criteria associated with any category so selected, and the set of items associated with the category that satisfy the selection criteria. Category selection 900 occurs in response to a consumer selecting a category using the user interface 392 (process 902). The data relating the categories in a hierarchical structure is stored in a category index 905 that contains a series of relationships associating categories 910 with sub-categories 915, being the immediately subordinate categories. The categories found in response to a consumer browsing the available hierarchy are rendered by the user interface process 902, as discussed above with reference to FIGS. 7A to 7F.

Whenever the consumer selects a leaf-category, the selection engine 300 proceeds to decision process 920 to determine the set of selection criteria applicable. The set of selection criteria associated with each category is determined using a selection criteria index 925 that contains a series of relationships associating categories 930 with selection criteria 935. The set of selection criteria is then rendered by the user interface 902, as discussed with reference to FIGS. 8A to 8C.

Whenever the consumer selects a leaf-category or applies selection criteria, the selection engine 300 proceeds to decision process 940 to determine the set of items to be displayed. This determination involves two stages: (1) determination of the items associated with the category, followed by (2) restricting the set determined in stage (1) to only include those items matching the selection criteria determined in decision process 920 and assigned attribute values and whether the criteria is applied in the user interface 902.

The first stage is determined using an item index 945 that contains a series of relationships associating categories 950 with items 955. This set then populates set 970 for use in the second stage of the process.

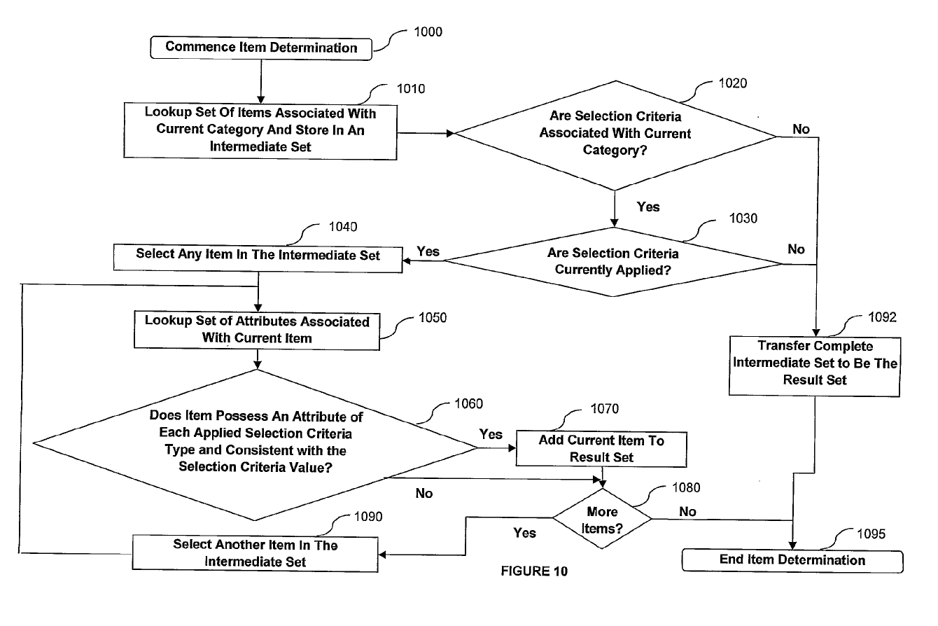

The second stage is determined using an item attribute index 965 that contains a series of relationships associating each of the items identified in the first stage 970 with the a set of attributes 975. The item determination process 940, as described in detail below with reference to FIG. 10, then performs the following sequence of steps:
(a) if no selection criteria were identified by process 920 then the result is the set 970 and the selection process ends.
(b) if selection criteria were identified by process 920 but not applied in the user interface 902 then the result is the set 970 and the selection process ends.
(c) the set of attributes found in set 935 is reduced to only contain those that have been applied in the user interface 902 to the selection. This reduced set is represented by set 980.
   (d) the set of items 970 is reduced to only contain those for which (a) each attribute in set 980 is also in set 975 for each retained item, and (b) the value (if any) for each attribute in set 980 is consistent with any corresponding value of each attribute of the same type in set 975.

The set of matching items is then communicated to user interface 902 to be rendered for presentation to the consumer.

The item determination process 940, as shown in FIG. 10, is performed by the server resident parts 302 of the selection engine 300 and is where relations 905, 925, 945, 965 and 980 all reside. The process 940 begins at step 1000 where it is assumed that the current category and sets of selection criteria 935 and 980 (if any) associated with and applied to that category respectively have already been determined as described above with reference to FIG. 9. Step 1010 represents the operation of using Item Index 945 to determine an intermediate set of items 955 (which is identical to set 970). Decision step 1020 determines whether 935 is an empty set. If set 935 is an empty set then the intermediate set determined at step 1010 becomes the result set of items at step 1092 and the process then proceeds to terminate at step 1095.

If the set 935 is not an empty set then the process 1000 proceeds to step 1030 to determine whether set 980 is an empty set. If set 980 is an empty set then no selection criteria are currently applied in the user interface 392 and the process then proceeds to step 1092 where the intermediate set determined at step 1010 becomes the result set of items. The process then proceeds to terminate at step 1095.

If it is determined at decision step 1030 that there are selection criteria 980 currently applied then the process proceeds to step 1040 to choose any one of the items in intermediate set 970. The process then proceeds to step 1050 to determine the set of attributes associated with that item using Item Attribute index 965 to determine the set of attributes 975.

The process 940 then proceeds to decision step 1060 to compare the set of selection criteria applied 980 with the set of attributes 975 associated with the current item under consideration from set 970. If each attribute in selection 980 is in set 975 and that attribute possess a value consistent with the associated member of set 980 then that item in set 970 is added to the result set at step 1070. The process then proceeds to decision step 1080 to determine whether there are other items in set 970 to consider. If it is determined at the step 1060 that the current item does not match the selection criteria then is it is not added to the result set and the process proceeds directly to decision step 1080.

If it is determined at decision step 1080 that there are further items in set 970 then the process proceeds to step 1090 to select another item for consideration. The process then reverts back to step 1050 to test whether that item matches the selection criteria.

If it is determined at decision step 1080 that there are no further items in set 970 to consider then the process proceeds to terminate at step 1095.

As an example of the selection process, the scenario of FIG. 8C can be used to illustrate the associated sets and values. In this case, the set 930 would contain the single value “Reverse Cycle Split Air Conditioners” and set 935 would contain each of nine selection criteria shown on that figure (ie “Air Output—Cool (L/s)” etc). In this case set 980 would contain two values “Air Output—Cool (L/s)” and “Capacity (KW) Heating”.

As can be appreciated from the above, the selection system 120 can assist item consumers rapidly identify and select the items of greatest interest with greater efficiency, less delay and optimised network traffic, and can assist item suppliers disseminate new and updated item information.

Many modifications will be apparent to those skilled in the art without departing from the scope of the present invention as herein described with reference to the accompanying drawings.

1. A selection system, including:
a user interface for use in selecting an item, said user interface being served to and stored on a user device only for the duration of a session, and for providing categories, selection criteria and item data selectable using said device; and
a server component for serving said user interface for said session, for serving only category data during said session, in response to selection of one of said categories when the category is not a leaf category, to change said categories provided by said user interface, and for serving only selection criteria and item data during said session in response to selection of a leaf category of said categories.

2. A selection system as claimed in claim 1, wherein said user interface provides said selection criteria and item data of items of said leaf category for selection.

3. A selection system as claimed in claim 2, wherein said user interface provides item data of items of said leaf category selected using selection criteria served to said interface and having attribute data values corresponding to selected data values of selected selection criteria.

4. A selection system as claimed in claim 1, wherein said server component stores said category data representing hierarchical categories for items, and serves category data for a level of said categories for use by said interface to provide said level, and in response to selection of a category of said level, serves category data for at least one lower level relative to the selected category.

5. A selection system as claimed in claim 4, wherein the server part serves category data for a number of lower levels relative to the selected category.

6. A selection system as claimed in claim 5, including an administration manager component for setting the number of lower levels served.

7. A selection system as claimed in claim 6, wherein a category is associated with categories of the next level, and a leaf category is associated with said selection criteria and items.

8. A selection system as claimed in claim 7, wherein said selection criteria includes types of item attributes and attribute data values for said types.

9. A selection engine, stored on computer readable media, including:
a user interface part served and stored on a computer device during a user session; and
a server part for responding to requests from the user interface part to serve only item, category or selection criteria data during said session for said interface.

10. A selection engine, stored on computer readable media, including:
a user interface for use in selecting an item, said user interface being served to and stored on a user device only for the duration of a session, and for providing categories, selection criteria, and item data selectable using said device; and
said user interface receiving during said session only category data, in response to selection of one of said categories when the category is not a leaf category, to change said categories provided, and for receiving only selection criteria and item data during said session in response to selection of a leaf category of said categories.

11. A selection engine as claimed in claim 10, wherein said user interface provides said selection criteria and item data of items of said leaf category for selection.

12. A selection engine as claimed in claim 11, wherein said user interface provides item data of items of said leaf category selected using selection criteria served to said interface and having attribute data values corresponding to selected data values of selected selection criteria.

13. A selection engine as claimed in claim 10, wherein said categories are hierarchical, and category data for a level of said categories is received for use by said interface to provide said level, and in response to selection of a category of said level, category data for at least one lower level relative to the selected category is received.

14. A selection engine as claimed in claim 13, wherein category data for a number of lower levels relative to the selected category is received.

15. A selection engine as claimed in claim 14, wherein a category is associated with categories of the next level, and a leaf category is associated with said selection criteria and items.

16. A selection engine as claimed in claim 15, wherein said selection criteria includes types of item attributes and attribute data values for said types.

17. A selection system including:
means for serving a user interface for storage on a device only for the duration of a user session, for use in selecting an item, said user interface providing selectable categories, selection criteria and item data;
means for serving only category data during said session, in response to selection of one of said categories when the category is not a leaf category, to change said categories provided by said user interface; and
means for serving only selection criteria and item data during said session in response to selection of a leaf category of said categories.

18. A process, performed by a selection system, including:
serving a user interface, for storage on a device only for the duration of a user session, for use in selecting an item, said user interface being adapted to provide selectable categories, selection criteria and item data;
serving only category data during said session, in response to selection of one of said categories when the category is not a leaf category, to change said categories provided by said user interface; and
serving only selection criteria and item data during said session in response to selection of a leaf category of said categories.

19. A process, performed by a selection system as claimed in claim 18, wherein only the selection criteria and item data of items of said leaf category are provided for selection.

20. A process, performed by a selection system as claimed in claim 19, including providing item data of items of said leaf category selected using selection criteria served to said interface and having attribute data values corresponding to selected data values of selected selection criteria.

21. A process, performed by a selection system as claimed in claim 18, wherein said categories for items are hierarchical, and category data for a level of said categories is served for use by said interface to provide said level, and in response to selection of a category of said level, category data for at least one lower level relative to the selected category is served.

22. A process, performed by a selection system as claimed in claim 21, wherein category data for a number of lower levels relative to the selected category is served.

23. A process, performed by a selection system as claimed in claim 22, wherein a category is associated with categories of the next level, and a leaf category is associated with said selection criteria and items.

24. A process, performed by a selection system as claimed in claim 23, wherein said selection criteria includes types of item attributes and attribute data values for said types.

25. A selection system, including:
storage means storing first index data associating categories with items, second index data associating categories with selection criteria, and third index data associating items with attributes; and
response means processing request messages, in response to a selected category and selection criteria of the category, to serve item data for items of the selected category having attributes with data values corresponding to at least one data value of the selected selection criteria.

26. A selection system as claimed in claim 25, wherein said categories are leaf categories of a category hierarchy including levels of categories, and said storage means stores fourth index data associating categories of one level with categories of the next lower level, and said response means, in response to selection of a non leaf category serves category data for a least the next lower level category.

27. A selection system as claimed in claim 25, including a user interface served and stored on a client device only for a session, and which is adjusted during the session on the basis of the category data, selection criteria and item data served by the response means.

28-30. (canceled)
